(19) United States
(12) Patent Application Publication
(10) Pub. No.: US 2006/0146529 A1
(43) Pub. Date: Jul. 6, 2006

(54) Plastic light emitting band

(76) Inventor: Hsin-Yin Ho, Banchiau City (TW)

Correspondence Address: Hsin-Yin HO, P.O. Box No. 6-57, Junghe, Taipei, 235, TW

(21) Appl. No.: 11/028,188

(22) Filed: Jan. 4, 2005

(51) Int. Cl. F21V 1/00; F21V 11/00

(52) U.S. Cl. 362/235

(57) ABSTRACT

A plastic light emitting band includes plastic conductors and light emitters combined by a method of contact conduction. The method of contact conduction includes conduction methods without using an outside force, such as surface contact, piercing contact, clipping contact, and entangling contact, which can connect with a power supply without using the outside force, and can enlighten the light emitters through the plastic conductors.

### BACKGROUND OF THE INVENTION

(a) Field of the Invention

The present invention relates to a plastic light emitting band, and more particularly to a band shape light emitter with high plasticity and light emitting function, which can be particularly used in boats, stairs, advertisement marquees, lighting lamps, warning lamps, or Christmas trees having light emitting bands with lighting, warning, or eye-catching functions.

(b) Description of the Prior Art

In general, for the convenience of using lamps for decoration of a Christmas tree, a power cord is often used to connect a plurality of lamps in a series to constitute a strip and thereby surrounding the Christmas tree. These lamps can also be installed at edges of stages, stairs, or boats, and connected with a power supply for lighting the lamps, in order to add a visual impression.

However, for lamps generally connected by a power cord into a series, the lamps can be incomplete and the effect of application of the lamps can be greatly reduced, due to the short lifetime and vulnerability to outside force of the lamps.

For the aforementioned lamps connected into a series, a lamp holder is mounted at each position of the lamps in order to insert a lamp, for the sake of providing a user with the capability of replacing lamps himself, thereby increasing the convenience in replacing the lamps. However, as the lamps are exposed outside, they are vulnerable to damage. In addition, as the lamps are formed by entangling at least two power cords into a series, it is very inconvenient to collect the lamps and the power cords are easily twisted together during collection, thereby producing a major problem.

### SUMMARY OF THE INVENTION

Accordingly, the present invention of a plastic light emitting band combines primarily a plastic conductor with a light emitter with a method of contact conducting, wherein the contact conducting method includes surface contact, piercing contact, clipping contact, and entangling contact which do not rely on an outside force. With this method of contact conducting, power can be connected without using the outside force, thereby directly lighting the light emitter through the plastic conductor.

The object of the present invention is to constitute a light emitting band by combing the plastic conductor with the light emitter, which can be widely used in boats, stairs, advertisement marquees, lighting lamps, or warning lamps, to achieve the functions of lighting, warning, and eye-catching.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a cross sectional view of a first implementation of the present invention.

FIG. 2 shows a cross sectional view of a second implementation of the present invention.

FIG. 3 shows a schematic view of the second implementation of the present invention.

FIG. 4 shows a cross sectional view of a third implementation of the present invention.

FIG. 5 shows a schematic view of a fourth implementation of the present invention.

FIG. 6 shows a cross sectional view of a fifth implementation of the present invention.

FIG. 7 shows a cross sectional view of a sixth implementation of the present invention.

FIG. 8 shows a cross sectional view of a seventh implementation of the present invention.

FIG. 9 shows a cross sectional view of an eighth implementation of the present invention.

FIG. 10 shows a cross sectional view of a ninth implementation of the present invention.

FIG. 11 shows a cross sectional view of a tenth implementation of the present invention.

FIG. 12 shows a cross sectional view of an eleventh implementation of the present invention.

FIG. 13 shows a cross sectional view of a twelfth implementation of the present invention.

FIG. 14 shows a cross sectional view of a thirteenth implementation of the present invention.

FIG. 15 shows a cross sectional view of a fourteenth implementation of the present invention.

FIG. 16 shows a schematic view of a fifteenth implementation of the present invention.

FIG. 17 shows a schematic view of a sixteenth implementation of the present invention.

### DETAILED DESCRIPTION OF THE PREFERRED EMBODIMENTS

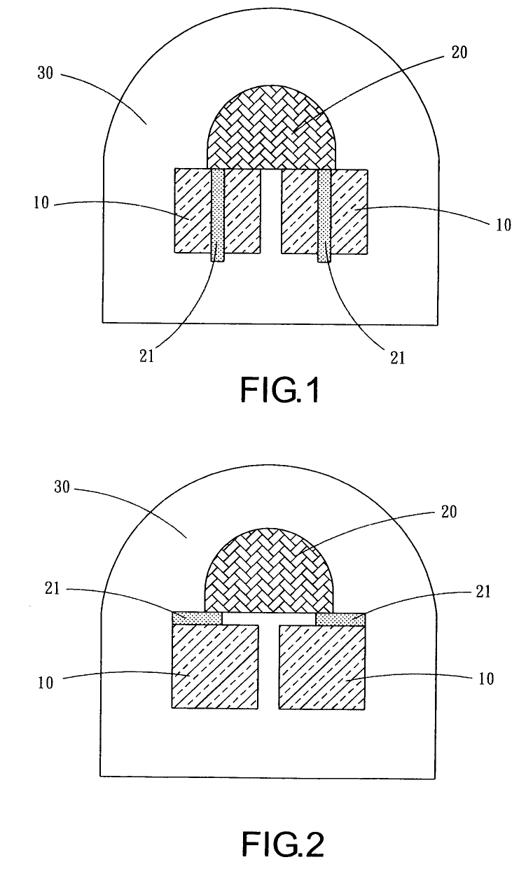

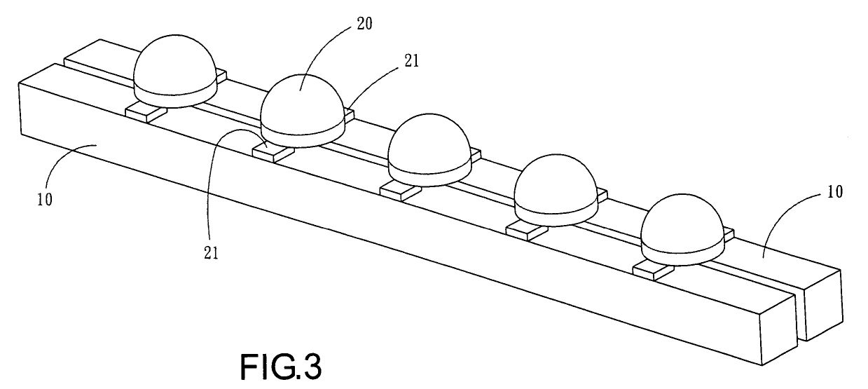

Referring to FIG. 1 to FIG. 3, the present invention of a plastic light emitting band comprises primarily at least two strips or bands of plastic conductor 10, and a plurality of light emitters 20, wherein the conductor 10 can be made of elastic or deformable material such as a conductive rubber or silicon. The conductor 10 and the light emitter 20 are combined by a method of contact conduction. As shown in the figures, two pins 21 of the light emitters 20 are pierced through or contacted with the conductors 10, such that each pin 21 is in contact with the conductors 10. In addition, after combining, a layer of cladding 30, made of a transparent, water-proof and insulated material, is wrapped around the light emitters 20 and the two conductors 10, thereby constituting a band shape light emitter.

Accordingly, as each conductor 10 is connected to a positive and negative of a power supply separately, states of positive and negative are formed for the two conductors 10, respectively, so as to conduct the two pins 21 of the light emitters 20, and to enlighten the light emitters 20 to release light and transmit out of the cladding layer 30, constituting an entire light emitting band, and thereby widely applying to boats, stairs, advertisement marquees, lighting lamps, warning lamps, or Christmas trees, and achieving the functions of lighting, warning, or eye-catching.

In addition, as the interior of the light emitting band is made of plastic conductors 10, breaking and rupture of conductors 10 can be avoided, and a twisting phenomenon can be reduced upon collecting, thereby increasing the convenience in collecting.

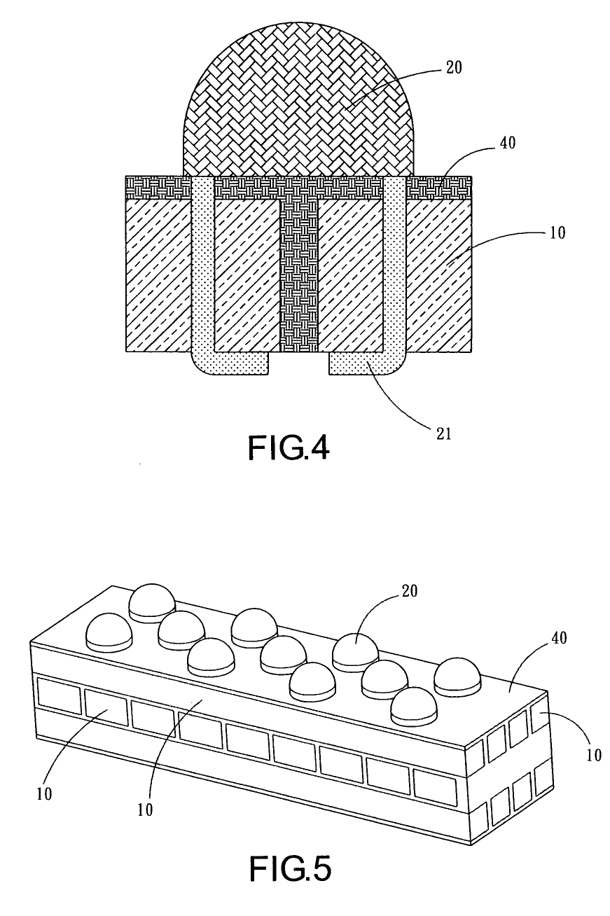

Referring to FIG. 4 and FIG. 5, a layer of insulation 40 can be installed between light emitters 20 and two conductors 10, such that an effect of isolation can be achieved with the layer of insulation 40, and a phenomenon of short-circuit to power supply can be avoided when the conductors are connected with positive and negative, respectively. Moreover, pins 21 of the light emitters 20 can be bended over below the conductors 10 after piercing through the conductors 10, constituting a state of clipping, thereby increasing the contact effect between the light emitters 20 and the conductors 10. In addition, the conductors 10 can manifest a state of weaving or multi-layer interlacing, which is formed by combining the light emitters 20 with the insulation layer 40.

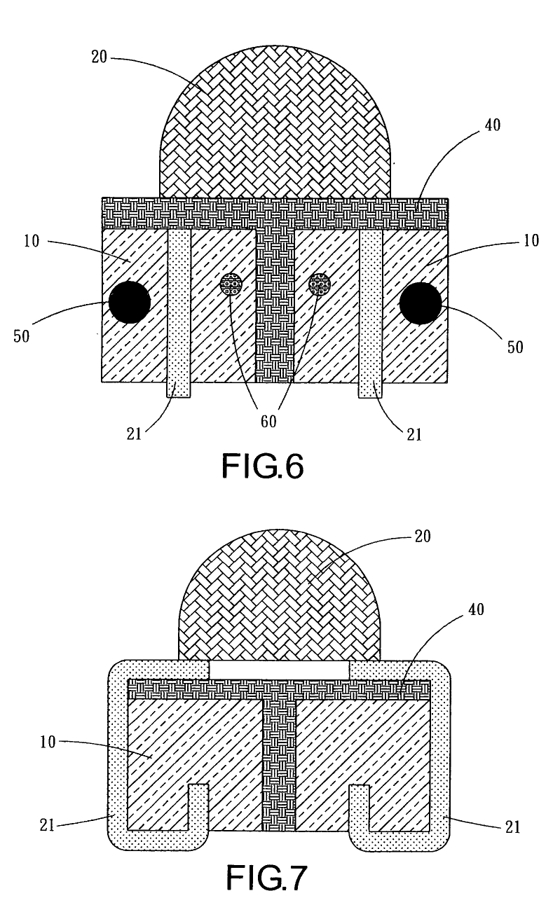

Referring to FIG. 6 and FIG. 7, a material with high conductance 50 can be installed inside conductors 10 to increase the conduction effect of the entire conductors 10, upon connecting the conductors 10 with a power supply. Pins 21 of light emitters 20 can be surrounding the conductors 10, and tail ends of the pins 21 can be inserted inside the conductors 10, such that the light emitters 20 can be reliably in conduction with the conductors 10. In addition, a wire 60 with high tensile strength can be installed inside the conductors 10. The wire 60 is made of material of good plasticity, such as steel thread, or man-made fiber, to increase the tensile strength of the conductors 10, and create various effects.

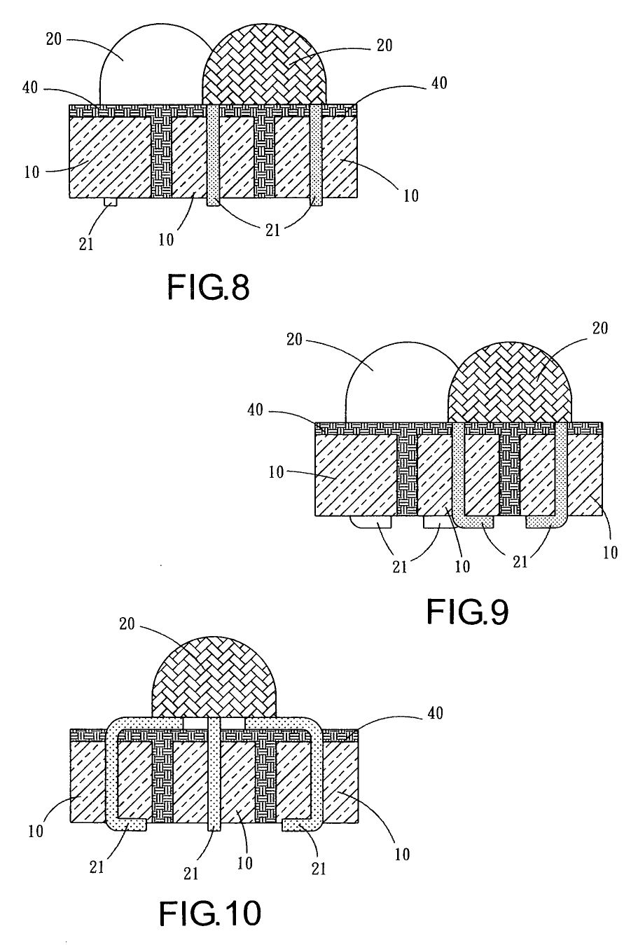

Referring to FIG. 8 to FIG. 10, it shows an implementation with three strips of conductors 10. Light emitters 20 manifest a state of interlacing, and pins 21 of the light emitters are inserted into two conductors 10, followed by being bended over at one side of the bottom of the conductors 10. Light emitters 20 with three pins 21 can be directly installed on the conductors 10, as well, to increase the density between the whole light emitters, and generate a better lighting effect.

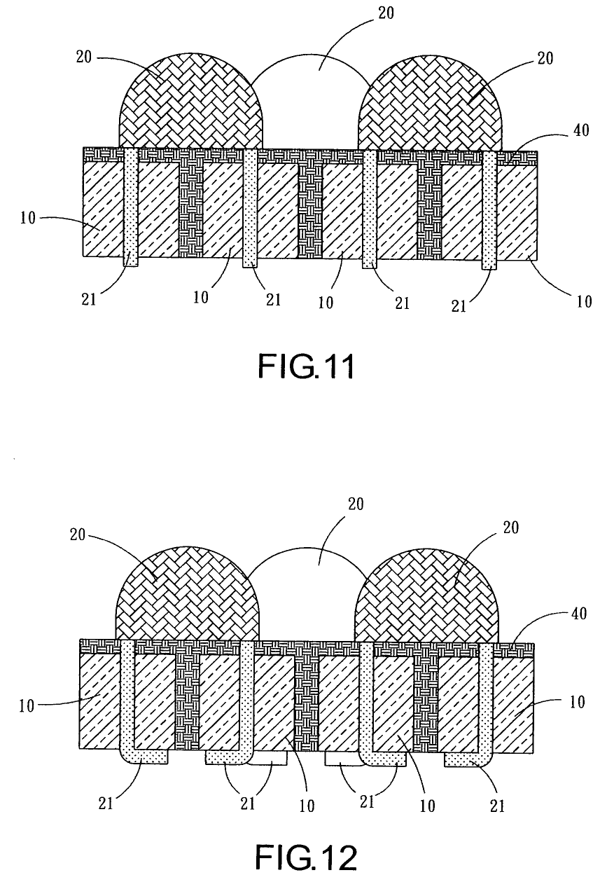

Referring to FIG. 11 and FIG. 12, it shows an implementation with four strips of conductors 10. Light emitters 20 manifest a state of parallel and interlacing, and two pins 21 of the light emitters 20 are inserted into conductors 10, respectively, so as to enlighten the light emitters 20. In addition, the pins 21 can be bended over at one side of the bottom of the conductors 10, as well.

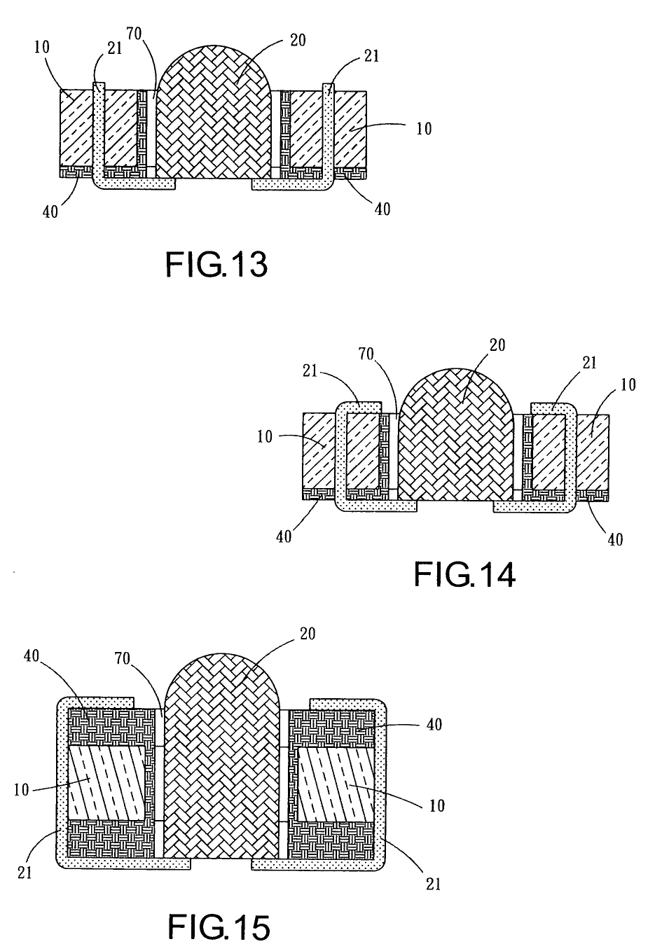

Referring to FIG. 13 to FIG. 15, light emitters 20 can pass through a center of two conductors 10 and constitute a through-hole 70, such that the light emitters 20 are roughly protruded at the top of the two conductors 10. In addition, an insulation layer 40 is installed at a position between the conductors 10 and the light emitters 20, and two pins 21 of the light emitters 20 are inserted in the conductors 10 from the bottom of the conductors 10, or pierced through the conductors 10 and bended over at one side of the top of the conductors 10. Moreover, the pins 21 can be extended from the bottom of the conductors 10, and be surrounding the conductors 10, so as to constitute a state of conduction for the pins 21 and the conductors 10.

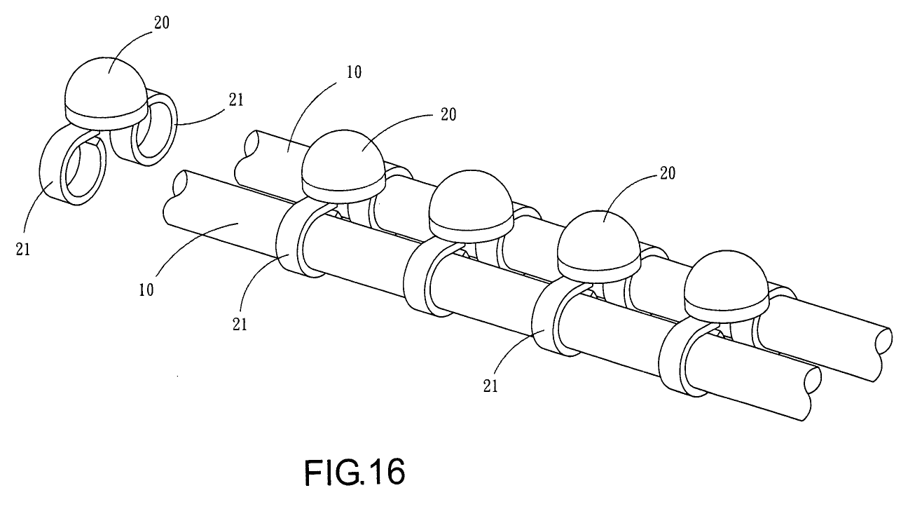

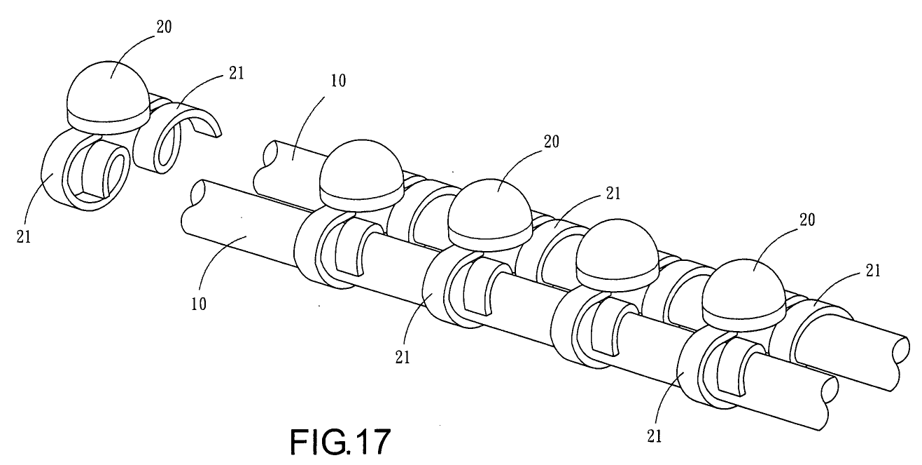

Referring to FIG. 16 and FIG. 17, it shows an implementation with a circular cross section of conductors 10. Pins 21 of light emitters 20 are wrapped to a loop shape, such that the conductors 10 can be passed through an interior of the loop-shaped pins 21, and an entangling contact state can be manifested, in order to increase the contact area between the pins 21 and the conductors 10, and more reliably fix the light emitters 20 on the conductors 10.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A plastic light emitting band comprising primarily at least two strips of plastic conductors, and a plurality of light emitters, combined by a method of contact conduction, thereby connecting with a power supply by the conductors and lighting the light emitters.

2. The plastic light emitting band according to claim 1, wherein a layer of cladding is wrapped around the light emitters and the conductors; the layer of cladding made of transparent, water-proof and insulation material.

3. The plastic light emitting band according to claim 1, wherein at least two pins are installed in the light emitters.

4. The plastic light emitting band according to claim 1, wherein the conductors are made of elastic or deformable material such as a conductive rubber or silicon.

5. The plastic light emitting band according to claim 1, wherein a layer of insulation is surrounding the conductors.

6. The plastic light emitting band according to claim 1, wherein the conductors can manifest a state of strip, band, weave, or multiple layer interlacing.

7. The plastic light emitting band according to claim 1, wherein a high conductance material is installed inside the conductors.

8. The plastic light emitting band according to claim 1, wherein a through-hole method is used for the light emitters and the conductors for achieving a contact effect.

9. The plastic light emitting band according to claim 1, wherein an entangling method is used for the light emitters and the conductors for achieving a contact effect.

10. The plastic light emitting band according to claim 1, wherein a clipping method is used for the light emitters and the conductors for achieving a contact effect.

11. The plastic light emitting band according to claim 1, wherein a wire made of high tensile strength is installed inside the conductors.

12. The plastic light emitting band according to claim 1, wherein the wire is made of plastic and deformable material such as steel thread, or man-made fiber.
